(19) United States
(12) Patent Application Publication
(10) Pub. No.: US 2005/0095416 A1
(43) Pub. Date: May 5, 2005

(54) Inorganic porous materials containing dispersed particles

(75) Inventors: Shigeru Hanzawa, Kagamihara-shi (JP); Yousuke Sato, Nagoya-city (JP); Naohiro Soga, Kobe-shi (JP); Kazuki Nakanishi, Kyoto-shi (JP)

Correspondence Address: BURR & BROWN, PO BOX 7068, SYRACUSE, NY, 13261-7068, US

(73) Assignees: NGK Insulators, Ltd., Nagoya-Shi (JP); Naohiro SOGA, Kobe-Shi (JP); Kazuki NAKANISHI, Kyoto-Shi (JP)

(21) Appl. No.: 10/700,321

(22) Filed: Nov. 3, 2003

(51) Int. Cl. B32B 3/06

(52) U.S. Cl. 428/304.4; 428/306.6; 428/307.3

(57) ABSTRACT

An object of the present invention is to provide an inorganic porous body having an inorganic porous bone structure as the main body in which various kinds of particles can be uniformly loaded onto the wall surface facing the open pores. The inorganic porous composite body has an inorganic porous bone structure with open pores formed therein and particles for dispersion exposing to the wall surfaces of the bone structure facing the open pores. The bone structure is generated by sol-gel transition accompanied by phase transition.

### TECHNICAL FIELD OF THE INVENTION

The present invention relates to an inorganic porous material containing dispersed particles.

### BACKGROUND

An inorganic porous material, generally represented by ceramics, is produced by binding raw material of fine particles with a resin component called a binder or pore-forming agent to obtain a compact and by sintering the compact so that the binder is fired. The binder is fired and dissipated so that spaces occupied by the binder are left between the resulting sintered particles to form pores.

### DISCLOSURE OF THE INVENTION

It is, however, difficult to disperse and adhere various kinds of particles onto the inner wall surface facing small holes of a sintered body. For example, when particles for dispersion are mixed to raw material particles for sintering, the particles for dispersion tend to be aggregated and mixed into the resulting sintered body and not to be adsorbed onto the inner wall surface facing the small holes. It is further considered that, after a sintered body is produced, a liquid containing particles for dispersion is injected into the small holes of the sintered body and then solidified. The resulting sintered body, however, has small holes having uneven shapes, many necks, and a broad distribution of sizes of small holes. Further, it is difficult to increase the size of small holes to a value beyond a some limit. It is thus difficult to uniformly adhere the different kind of particles into the small holes of the sintered body so that the particles are loaded in the small holes. It is also difficult to uniformly disperse particles for dispersion having a larger size to some degree in the small holes of the sintered body.

On the other hand, it is known that a porous body of silica can be produced with a high reproducibility by means of a sol-gel process accompanied by phase separation (U.S. Pat. No. 2,123,708 and Japanese Patent No. 3-285833A). According to the method, the shape of small holes and size distribution can be made considerably homogeneous. Further, it is possible to form small holes having a relatively large diameter. The porous body, however, is homogeneous as a whole and made of, for example, silica. It is thus difficult to impart various kinds of functions to the porous body so that the applications of the porous body are limited.

An object of the present invention is to provide an inorganic and composite porous body comprising a porous bone structure of an inorganic material as a main component, so that various kinds of particles can be loaded uniformly into the bone structure without introducing roughness of the wall surface facing the open pores.

The present invention provides an inorganic porous body comprising an inorganic porous bone structure with open pores formed therein, and particles for dispersion exposing to an inner wall surface of the porous bone structure facing the open pores, wherein the porous bone structure is generated by sol-gel transition accompanied by phase transition.

According to the present invention, the porous bone structure is produced by sol-gel transition accompanied with phase transition and the particles for dispersion are exposed to the inner wall surface facing the open pores. According to such bone structure, the pore size can be controlled or increased, neck parts can be reduced and the uniformity of the pore size of the open pores is improved. It is further possible to disperse the particles uniformly onto the wall surface facing the open pores and to control the amount of the dispersed particle with ease. Various functions of the dispersed particles in the porous body can be utilized at a high efficiency which has not been obtained in a porous bone structure of a prior art.

Further, according to the porous body of the present invention, each of the particles for dispersion is exposed to the wall surface of the porous body facing the open pores. Preferably, 1 vol. % or more, more preferably 5 vol. % or more of the whole volume of the dispersed particles is out of the wall surface into the open pores in the porous bone structure.

### BRIEF DESCRIPTION OF THE DRAWINGS

FIG. 1 is a photograph showing a cross section of an inorganic porous composite body with an amount of dispersed particle being 0.0 g in the example, taken by a scanning electron microscope (at a magnitude of 5000).

FIG. 2 is a photograph showing a cross section of an inorganic porous composite body with an amount of dispersed particle being 0.5 g in the example, taken by a scanning electron microscope (at a magnitude of 20000).

FIG. 3 is a photograph showing a cross section of an inorganic porous composite body with an amount of dispersed particle being 1.0 g in the example, taken by a scanning electron microscope (at a magnitude of 5000).

FIG. 4 is a photograph showing a cross section of an inorganic porous composite body with an amount of dispersed particle being 1.0 g in the example, taken by a scanning electron microscope (at a magnitude of 20000).

FIG. 5 is a photograph showing a cross section of an inorganic porous composite body with an amount of dispersed particle being 2.0 g in the example, taken by a scanning electron microscope (at a magnitude of 5000).

FIG. 6 is a photograph showing a cross section of an inorganic porous composite body with an amount of dispersed particle being 2.0 g in the example, taken by a scanning electron microscope (at a magnitude of 20000).

### BEST MODES FOR CARRYING OUT THE INVENTION

The present invention will be described further in detail below.

According to the present invention, the porous bone structure is generated by sol-gel transition accompanied by phase transition. For performing the reaction, a solution containing a precursor of a network-forming component is produced, the precursor in the solution is then reacted, for example hydrolyzed to generate sol, and the sol is gelled (solidified). The process is called “sol-gel transition”. Phase transition of a phase rich in the network-forming component for causing gellation (gel phase) and a phase rich in a solvent component irrelevant of gellation (solvent phase) is induced parallel to sol-gel transition. As a result, the gel forms a network like structure, so that the solvent phase is dried to remove the solvent to obtain the porous body having the open pores.

According to the present invention, after the porous body is obtained, a slurry containing particles for dispersion may be filled into the open pores of the porous body and the porous body may be heat treated. The particles for dispersion are thus exposed to the open pores in the porous body.

In a preferred embodiment, however, the particles for dispersion are made coexisted in the sol-gel reaction solution in advance. Many of the particles for dispersion are exposed to the wall surface facing the open pores of the network like structure after the sol-gel reaction. In this case, the particles for dispersion can be dispersed more uniformly onto the wall surfaces of the porous body facing the open pores.

More detailed description will be given below.

In a preferred embodiment, the particles for dispersion are made coexisted in the sol-gel reaction solution to cause the sol-gel transition accompanied by phase transition. The porous bone structure with open pores formed therein is thus generated and the particles for dispersion are exposed to the wall surface facing the open pores.

In the sol-gel reaction system, phase separation occurs as time passes by. That is, the system is separated to a phase rich in a network-forming component causing gel formation (gel phase) and a phase rich in a solvent component not involved in the gel formation (solvent phase). In the formation of the phases, each component is diffused inversely with respect to the gradient of concentration based on a difference of chemical potential as the driving force. The movement of substances is continued until each phase reaches an equilibrium composition specified at a given temperature and pressure. For the reaction, the particles for dispersion are made coexisted in a starting composition and conditions are selected so that the particles for dispersion does not considerably affect the phase separation and sol-gel reaction.

Specific manufacturing methods are examplified below.

(1) Particles for dispersion are added to a solvent, which is then stirred and subjected to ultrasonic treatment to disperse them. A precursor of a network-forming component is dissolved in the solvent so that a reaction is caused to generate the network-forming component and to proceed the sol-gel transition and phase separation reactions.

(2) A network-forming component is dissolved into a solvent to obtain a solution. To the solution, a dispersion of the particles is added, stirred and subjected to ultrasonic treatment. A reaction for generating the network-forming component is thus caused and the sol-gel transition and phase separation reactions are proceeded.

After the step of (1) or (2), the resulting moisture gel is washed or the solvent is exchanged with another solvent. The solvent is then removed to obtain an inorganic porous composite body. If required, the inorganic porous composite body may be heat treated at an appropriate temperature.

The pore size of the open pores of the porous bone structure may preferably be 100 nm or more, and more preferably be 200 nm or more, for improving permeability of the open pores. Such macro hole is formed in a region occupied by the solvent phase generated in the phase separation process. When a so-called co-continuous structure, in which the solvent and gel phases are both interconnected, respectively, a considerably sharp size distribution can be obtained.

Although the upper limit of the pore size (diameter) of the open pores is not particularly limited, it may preferably be 10000 nm or lower on the viewpoint of productivity.

The porous bone structure may be made of an inorganic material not particularly limited. A metal oxide is particularly preferred. The metal oxide includes silicon oxide, titanium oxide, zirconium oxide and alumina. Two or more kinds of the metal oxide may be used at the same time.

Particles for dispersion produced and commercialized in an industry now are mainly composed of an organic polymer, a metal oxide or a metal, and the size (average diameter) is in a considerably broad range of about 5 nm to 100 μm. It is known that chemical affinity of the fine particles and the network-forming component causing gel formation can be easily controlled by chemically modifying the surface of the particles, in many cases. As far as particles satisfy the requirement of not causing aggregation or precipitation during the sol gel reaction, the particles may be applied to the process of the present invention irrelevant of the chemical composition.

Particles for dispersion used in the present invention include a metal oxide, a metal, an organic polymer, and the composite materials thereof. Specifically, silicon oxide, titanium oxide, zirconium oxide, aluminum oxide, calcium oxide, magnesium oxide, iron oxide and the oxides of the other transition metals, and the oxides of rare earth elements such as yttrium oxide and lanthanum oxide may be used. It may be further used a carbonate, nitrate, sulfate, phosphate, halide, or the other inorganic salts stable in the reaction solution. Fine particles made of an organic polymer such as an organic salt, complex, protected metal colloid, polymer latex or the like may be used for producing the inorganic porous composite body according to the present invention, by controlling the dispersion of the particles in the reaction solution.

The mean particle diameter of the particles for dispersion is not particularly limited. The particles should have a diameter so that the particles can be filled into the open pores of the porous body. It is thus required that the mean particle diameter of the particles for dispersion is smaller than the pore size (diameter) of the open pores of the porous body. On the viewpoint of utilizing a function in the open pores, the mean particle diameter of the particles may preferably be smaller, by some degree, than the diameter of the open pores. On such viewpoint, the diameter of the particles for dispersion may preferably be 500 nm or smaller.

The mean particle diameter of the particles for dispersion may preferably be 5 nm or larger for preventing the aggregation during the dispersion. Further, when the mean particle diameter of the particles is too small compared with the diameter of the open pores, the contact of liquid passing through the open pores with the particles may be prevented so that the function cannot be effectively utilized. For base materials used in the present invention, (“a diameter “D” of the open pores of the porous body without the particles for dispersion)/(a diameter “d” of the particles for dispersion) may preferably be 600 or smaller and more preferably be 100 or smaller.

Further, when the particles for dispersion have an elongate shape, the state around each particle may be easily changed during the phase transition to result in irregularities on the inner wall surface facing the open pores. On the viewpoint of preventing the irregularities, the average aspect ratio (long axis/short axis) of the particles for dispersion may preferably be 1.5 or lower.

The weight ratio of the particles for dispersion may preferably be 90 weight percent or lower, and more preferably be 80 weight percent or lower with respect to the whole weight of the inorganic porous composite body.

Further, on the viewpoint of utilizing the function of the particles for dispersion, the weight ratio of the particles for dispersion may preferably be 0.01 weight percent or more, and more preferably be 0.1 weight percent or more, with respect to the whole weight of the inorganic porous composite body.

The functions of loading the particles for dispersion in the open pores is not particularly limited. For example, it may be a function of introducing a surface roughness of increasing the surface roughness of the inner wall surfaces facing the open pores to enlarge the contact area of liquid and the inner wall surfaces of the porous bone structure. Further, it may be loaded a function of catalyzing a chemical reaction.

The precursor for the network-forming component for causing gellation in the sol-gel reaction includes the followings.

(1) A metal alkoxide, a metal complex, a metal salt, a metal alkoxide modified with an organic substance, a metal alkoxide with cross linked organic substance, or an organic metal alkoxide organic replaced with an alkyl group

(2) A partially hydrolyzed product of a metal alkoxide, a metal complex, a metal salt, a metal alkoxide modified with an organic substance, a metal alkoxide with cross linked organic substance, or an organic metal alkoxide replaced with an alkyl group

(3) A polymer product of partial polymerization of a metal alkoxide, a metal complex, a metal salt, a metal alkoxide modified with an organic substance, a metal alkoxide with cross linked organic substance, or an organic metal alkoxide replaced with an alkyl group

(4) Sol-gel transition by means of changing the pH of water glass or aqueous solution of the other silicate

Further in a more specific manufacturing process, a water soluble polymer is dissolved in an acidic aqueous solution, the particles for dispersion are added, stirred and subjected to ultrasonic treatment to disperse the particles in the solution. The precursor, more preferably a metal compound having a hydrolyzable functional group, is then added to the solution to cause hydrolysis. The degree of polymerization of the precursor of the network-forming component is gradually increased so that the miscibility between the polymer phase and solvent phase containing water, or solvent phase containing a water soluble polymer, as the main component is reduced. During the process, spinodal decomposition is induced parallel to gellation which is proceeded by the hydrolysis and polymerization of the network-forming component in the solvent. The product is then dried and heated.

Any water soluble polymer may be used, as far as it may be used for producing an aqueous solution having an appropriate concentration and may be uniformly dissolved into a reaction system containing an alcohol generated from a metal compound having a hydrolyzable functional group. Specifically, it is preferred the sodium salt or potassium salt of polystyrene sulfonate as the metal salt of a polymer; polyacrylic acid as an acid of a polymer dissociated to generate a polyanion; polyallyl amine and polyethylene imine as the base of a polymer dissociated to generate a polycation; polyethylene oxide as a neutral polymer having an ether bond in the main chain; or polyvinyl pyrrolidone or the like. Further, instead of the organic polymer, formaldehyde, a polyalcohol, and surface active agent may be used. In this case, glycerin as the polyalcohol and polyoxyethylene alkyl ether as the surfactant are most preferred.

The metal compound having a hydrolyzable functional group may be a metal alkoxide or the oligomer. The alkoxide may preferably have an alkyl group having a small number of carbon atoms such as methoxy, ethoxy, propoxy group or the like. The metal therefor is that constituting the metal oxide to be finally produced, such as Si, Ti, Zr or Al. One or more metals may be used. On the other hand, the oligomer may be uniformly dissolved or dispersed in an alcohol and specifically the number of repetition may be up to about 10. Further, an alkyl alkoxy silane in which some of the alkoxy groups in a silicon alkoxide are replaced with an alkyl group, and the oligomer having a repetition number up to about 10 may be preferably used. Further, a metal alkoxide replaced with alkyl group containing titanium, zirconium, aluminum or the like as the main metal element instead of silicon may be used.

Further, the acidic aqueous solution may preferably have 0.001 N or more of a mineral acid, normally hydrochloric acid, nitric acid or the like, or 0.01 N or more of an organic acid such as formic acid, acetic acid or the like.

The hydrolysis and polymerization reactions can be performed by holding the solution at a temperature of room temperature to 40 or 80° C. at 0.5 to 5 hours. The gellation and phase separation may be caused during the process.

### EXAMPLES

### Example 1

0.9 g of polyethylene oxide (supplied by Aldrich Co.) as the water soluble polymer was uniformly dissolved in 11.3 ml of 0.01 mol/L acetic acid solution to obtain a solution. Silica particles (particles for dispersion: “SO-C2” supplied by Admatech Co.: mean particle diameter of 0.4 to 0.6 μm) was added to the solution, stirred for 5 minutes, and further subjected to ultrasonic treatment to disperse them. After that, the solution was stirred for 10 minutes under cooling with ice, and 5.7 ml of tetramethoxysilane (a precursor for a network-forming component: supplied by Shin-Etsu Chemical Co., Ltd.) was added under stirring to perform hydrolysis. The thus obtained transparent solution was sealed and held in a constant temperature bath at 40° C. so that the solution was solidified. The thus obtained gal was aged for about 24 hours at the same temperature and then dried at 60° C. to obtain a bulky and porous composite body.

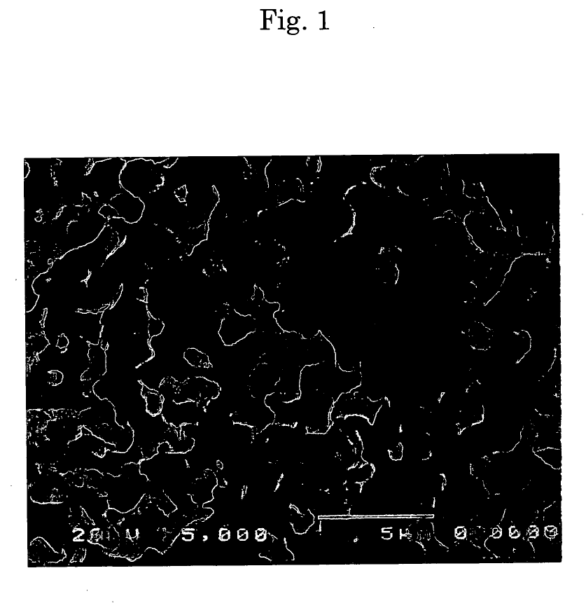

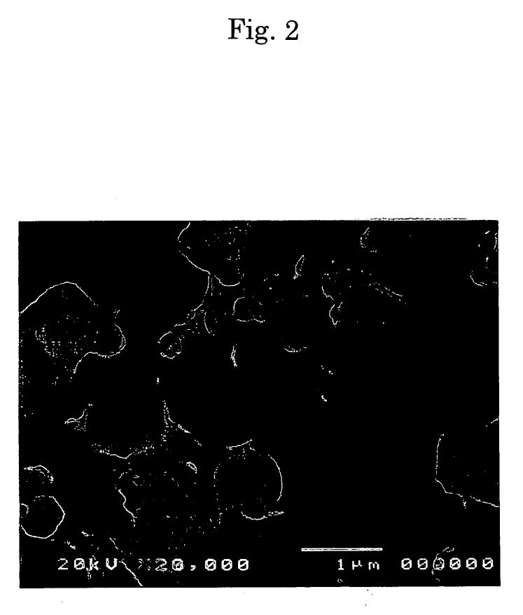

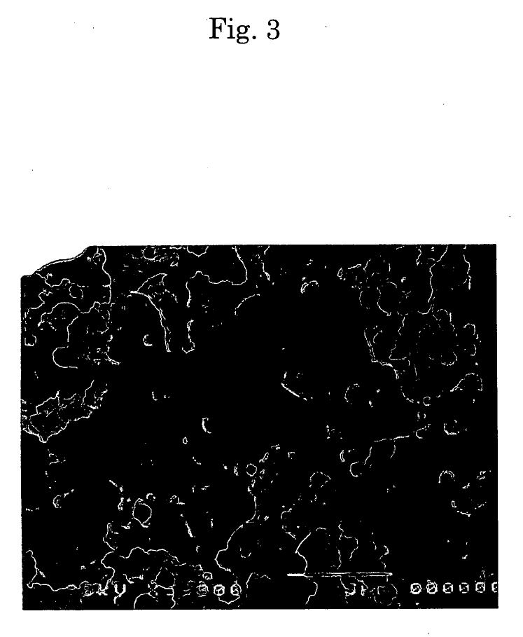

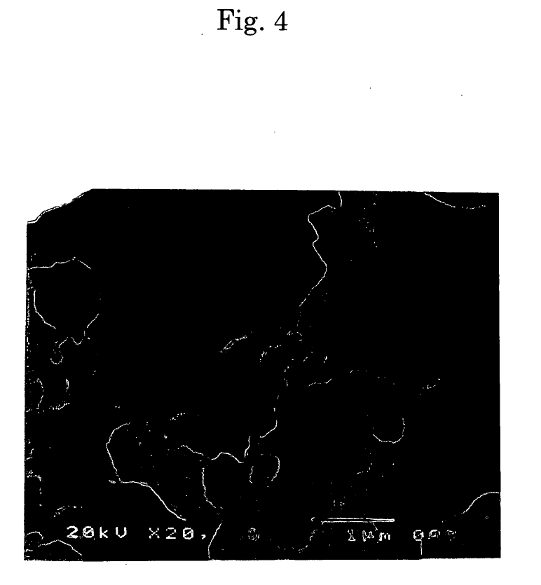

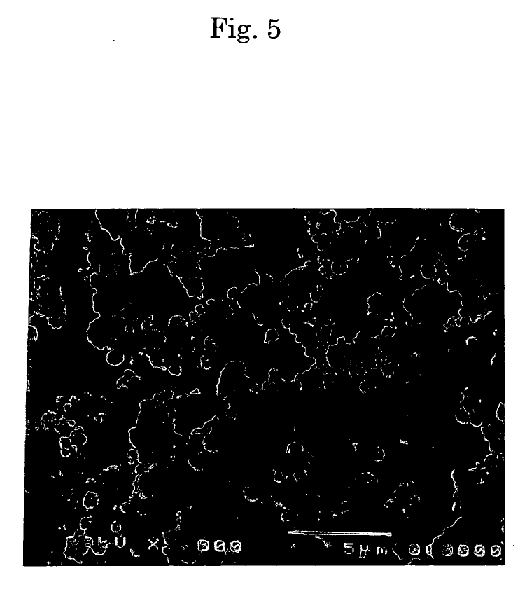

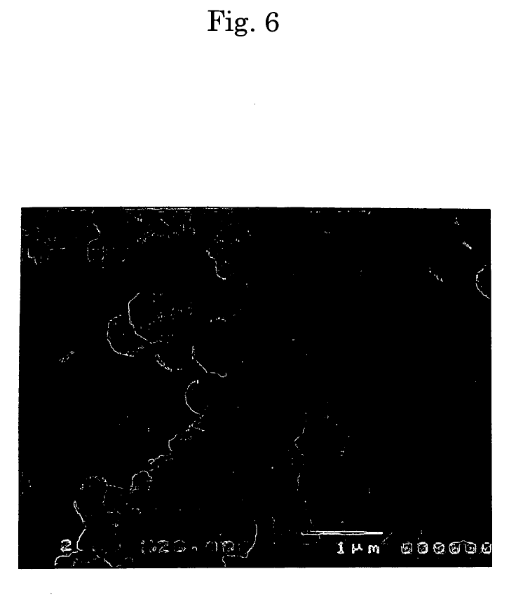

The weight of the silica particles (particles for dispersion) was changed to 0.1 g, 0.5 g, 1.0 g or 2.0 g. The weight percentage of the particles for dispersion was 4.13, 17.7, 30.1 or 46.3 weight percent with respect to the whole weight of an inorganic porous composite body. In each of the examples, a porous body having co-continuous holes can be obtained. In each of the inorganic porous composite bodies, the photograph of the polished surface was taken by a scanning electron microscope (at a magnitude of 5000 or 20000). The following figures were presented now.

| | | | | |
|---|---|---|---|---|
| (FIG. 1) | Particles for dispersion: | 0.0 g, | magnitude; | ×5000 |
| (FIG. 2) | Particles for dispersion: | 0.5 g, | magnitude; | ×20000 |
| (FIG. 3) | Particles for dispersion: | 1.0 g, | magnitude; | ×5000 |
| (FIG. 4) | Particles for dispersion: | 1.0 g, | magnitude; | ×20000 |
| (FIG. 5) | Particles for dispersion: | 2.0 g, | magnitude; | ×5000 |
| (FIG. 6) | Particles for dispersion: | 2.0 g, | magnitude; | ×20000 |

As shown in FIG. 1, when the particles for dispersion are not added, the open pores of the porous bone structure is co-continuous and the wall surface facing the open pores is smooth. As shown in FIG. 2, when 0.5 g of the particles for dispersion are added, it was proved that round particles for dispersion was exposed to the wall surface facing the open pores. As shown in FIGS. 3 and 4, when 1.0 g of particles for dispersion are added, it was proved that a larger amount of the particles for dispersion were exposed to the wall surface facing the open pores. Further, as shown in FIGS. 5 and 6, when 2.0 g of particles for dispersion are added, the particles for dispersion are exposed to the wall surface facing the open pores. In addition to this, the amount and number of the exposed particles are increased and the pore size (diameter) of the open pores is lowered.

Besides, in the present example, (diameter “D” of open pores of porous body where no particles for dispersion are added)/(mean particle diameter “d” of particles for dispersion) was 2.5 and the average aspect ratio of the particles for dispersion was 1.1. The average aspect ratio of the particles for dispersion was calculated based on selected 50 samples from the SEM photograph.

### Example 2

Inorganic porous composite bodies were produced according to the same procedure as the example 1. In the example 1, however, silica particles (“SO-C1” supplied by Admatech Co.: mean particle diameter of 0.2 to 0.3 , m) was used as the particles for dispersion. The amount of the particles for dispersion was changed to 0.0 g, 0.5 g, 1.0 g or 2.0 g. In each of the inorganic porous composite bodies, the cross section of the each body was observed by a scanning electron microscope (at a magnitude of 5000 or 20000). As a result, the results of observation were substantially same as those in the example 1.

Besides, in the present example, (diameter “D” of open pores of porous body where no particles for dispersion are added)/(mean particle diameter “d” of particles for dispersion) was 3 and the average aspect ratio of the particles for dispersion was 1.1. The average aspect ratio of the particles for dispersion was calculated based on selected 50 samples from the SEM photograph.

As described above, the present invention provides a novel inorganic and composite porous body having a porous bone structure of an inorganic material as a main component, so that various kinds of particles can be loaded uniformly onto the wall surfaces facing the open pores.

1. An inorganic porous body comprising a porous bone structure with open pores formed therein and particles for dispersion exposing to wall surfaces of said porous bone structure facing said open pores, wherein said porous bone structure is generated by sol-gel transition accompanied by phase transition.

2. The inorganic porous body of claim 1, wherein said open pores have a diameter of 100 nm or larger.

3. The inorganic porous body of claim 1, wherein said particles for dispersion comprise one or more material selected from the group consisting of a metal oxide, a metal, an organic polymer and the composite thereof.

4. The inorganic porous body of claim 1, wherein said particles for dispersion have a mean particle diameter of 5 nm or larger and 100 μm or smaller.

5. The inorganic porous body of claim 1, wherein said inorganic material comprises a metal oxide.

6. The inorganic porous body of claim 1, wherein said particles for dispersion have an average aspect ratio of 1.5 or smaller.
